(19) United States
(12) Patent Application Publication
(10) Pub. No.: US 2026/0132302 A1
(43) Pub. Date: May 14, 2026

(54) INKJET INK

(71) Applicant: KYOCERA DOCUMENT SOLUTIONS INC., OSAKA (JP)

(72) Inventor: ARISA MORISHITA, OSAKA (JP)

(21) Appl. No.: 19/383,768

(22) Filed: Nov. 10, 2025

(30) Foreign Application Priority Data
Nov. 14, 2024 (JP) 2024-199092

(51) Int. Cl. C09D 11/326

(52) U.S. Cl. CPC C09D 11/326

(57) ABSTRACT

An inkjet ink is a water-based ink, including: a pigment, a water-based solvent, an alkaline agent, and a dispersion resin. The dispersion resin is a block polymer that includes a hydrophobic polymer block including benzylmethacrylate and a hydrophilic polymer block including methacrylic acid. The block polymer has an acid value of 180 mg KOH/g or more and 280 mg KOH/g or less, and the block polymer has a neutralization rate of 40% or more and 60% or less.

### CROSS-REFERENCE TO RELATED PATENT APPLICATION

This application claims the benefit of Japanese Priority Patent Application JP 2024-199092 filed on Nov. 14, 2024, the entire contents of which are incorporated herein by reference.

### FIELD OF THE DISCLOSURE

The present disclosure relates to an inkjet ink.

### BACKGROUND OF THE DISCLOSURE

Inkjet ink are desired to have even higher quality with the recent improvement in the quality of inkjet printers. For example, Japanese Patent No. 5636580 discloses a technology for improving print density by using a block polymer that includes a methacrylate-based hydrophobic polymer block and a hydrophilic polymer block containing methacrylic acid.

### SUMMARY OF THE DISCLOSURE

An inkjet ink according to an embodiment of the present disclosure is a water-based ink, including: a pigment; a water-based solvent; an alkaline agent; and a dispersion resin.

The dispersion resin is a block polymer that includes a hydrophobic polymer block including benzylmethacrylate and a hydrophilic polymer block including methacrylic acid.

The block polymer has an acid value of 180 mg KOH/g or more and 280 mg KOH/g or less, and the block polymer has a neutralization rate of 40% or more and 60% or less.

### DETAILED DESCRIPTION OF THE EXEMPLARY EMBODIMENTS

An embodiment of the present disclosure will be described below.

### [Configuration of Ink]

### (Schematic Configuration)

An inkjet ink according to an embodiment of the present disclosure (hereinafter, also referred to simply as an “ink”) is ejected from the recording head of an inkjet recording apparatus onto a recording medium to record an image on the recording medium. Examples of the recording medium on which an image is recorded by the ink according to this embodiment include plain paper, copy paper, recycled paper, thin paper, thick paper, glossy paper, and OHP.

The ink according to this embodiment is a water-based ink that includes a pigment, a water-based solvent, an alkaline agent, and a dispersion resin. The dispersion resin is a block polymer that includes a hydrophobic polymer block including benzylmethacrylate and a hydrophilic polymer block including methacrylic acid. The block polymer has an acid value of 180 mg KOH/g or more and 280 mg KOH/g or less, and the block polymer has a neutralization rate of 40% or more and 60% or less.

In order to enhance the rubfastness of an inkjet ink, one method involves increasing the acid value of a polymer dispersant (dispersion resin) to enhance the affinity with paper. However, increasing the acid value of the polymer dispersant tends to reduce print density depending on dispersion stability. Meanwhile, in order to increase print density, it is necessary to reduce the dispersion stability of pigments to cause the pigments to agglomerate. However, rubfastness deteriorates when print density increases. According to the ink according to this embodiment, it is possible to achieve both rubfastness and print density.

In this embodiment, rubfastness is ensured by increasing the acid value of the dispersion resin, and the dispersion stability of the pigments is reduced to cause the pigments to agglomerate by decreasing the neutralization rate of the dispersion resin. Further, the block polymer as the dispersion resin has a structure in which the hydrophilic part and the hydrophobic part are clearly separated, and the hydrophobic part coats the pigment to prevent the pigment from penetrating into paper, thereby increasing print density. As a result, it is possible to provide an ink capable of achieving both rubfastness and print density. The details thereof will be described below.

### (Pigment)

The water-based ink used in this embodiment includes a pigment as a coloring agent from the viewpoints of color mixing prevention of a printed matter and improvement in water resistance. The pigment may be either an inorganic pigment or an organic pigment. Further, these may be combined with an extender pigment as necessary.

Examples of the inorganic pigment include carbon black and metal oxide. In particular, in the case of a black ink, carbon black is favorable. Examples of the carbon black include furnace black, thermal lamp black, acetylene black, and channel black.

Specific examples of the organic pigment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

The hue is not particularly limited, and a colored pigment such as yellow, magenta, cyan, blue, red, orange, and green can be used. Specific examples of the favorable organic pigment include one or more products selected from the group consisting of C.I. Pigment Yellow, C.I. Pigment Red, C.I. Pigment Orange, C.I. Pigment Violet, C.I. Pigment Blue, and C.I. Pigment Green.

### (Dispersion Resin)

The dispersion resin used in this embodiment is a polymer dispersant in which the A block is a hydrophobic block polymer and the B block is a hydrophilic block polymer (hereinafter, also referred to as an AB block polymer). In this example, the A block is benzylmethacrylate that is a hydrophobic block polymer, and the B block is methacrylic acid that is a hydrophilic block polymer. That is, the AB block polymer is a benzylmethacrylate/methacrylic acid copolymer and can be obtained by living radical polymerization.

Regarding each of the A and B polymer blocks, the hydrophobic A block is adsorbed on the pigment surface and plays a role of coating the pigment while the hydrophilic B block has the carboxyl group to be ionized by an alkaline agent and plays a role of dissolving in the water-based solvent. The ionized carboxyl group has electrostatic repulsive force, thereby maintaining the dispersion stability in the liquid in combination with the three-dimensional obstacles of the dispersion resin structure. By using such an AB block polymer, it is possible to specialize the function of the hydrophobic A block for being adsorbed on the pigment and the function of the hydrophilic B block for electrostatic repulsive force and three-dimensional repulsive force.

The AB block polymer that is a dispersion resin used in this embodiment has an acid value of 180 mg KOH/g or more and 280 mg KOH/g or less.

In the low acid value region in which the acid value is less than 180 mg KOH/g, rubfastness is low because the amount of methacrylic acid that is an acid component is low. Further, in the above low acid value region, the dispersibility of pigment is poor and micronization is made difficult, resulting in a decrease in color development/coloration power.

Meanwhile, in the high acid value region in which the acid value exceeds 200 mg KOH/g, the amount of methacrylic acid that is an acid component is large and the pigments are less likely to agglomerate on the paper surface, resulting in a decrease in print density. Further, in the above high acid value region, preservation stability of the ink deteriorates.

The acid value can be obtained by, for example, a method according to JIS K 0070:1992 “Test methods for acid value, saponification value, ester value, iodine value, hydroxyl value and unsaponifiable matter of chemical products”.

The dispersion resin formed of a benzylmethacrylate/methacrylic acid block polymer having an acid value of 180 to 280 mg KOH/g favorably has a neutralization rate of 40% or more and 60% or less. When the neutralization rate of the dispersion resin is less than 40%, print density increases but rubfastness tends to decrease. When the neutralization rate of the dispersion resin exceeds 60%, rubfastness increases but print density tends to decrease.

Note that the neutralization rate refers to the proportion of the neutralized acid groups when the total number of acid groups included in the dispersion resin is regarded as 100%. The neutralization rate can be calculated from, for example, the amount of the basic compound used for neutralizing the dispersion resin during the preparation of the dispersion resin. Specifically, the neutralization rate refers to the percentage (100×M_{B}/M_{A}) of the usage amount M_{B} to the theoretical value M_{A}, M_{A} indicating the theoretical value of the amount of the basic compound necessary for completely neutralizing the dispersion resin, M_{B} indicating the usage amount of the basic compound used for neutralizing the dispersion resin. Note that M_{A} is calculated from, for example, the monomer composition of the dispersion resin.

In the case where high image quality is desired, a pigment dispersion in which the pigment is coated with a resin that includes fine particles and has a molecular weight of tens of thousands as the dispersion resin is suitable. Examples of the material satisfying the above conditions include a styrene acrylic resin.

Note that even if the acid value of the dispersion resin is within the above range, when the dispersion resin is a random polymer and the water-based solvent is hydrophobic, the pigment agglomerates, resulting in poor solvent resistance and inability to achieve print density. For this reason, when a hydrophobic solvent is used as a water-based solvent, the dispersion resin is favorably the above-mentioned benzylmethacrylate/methacrylic acid block polymer.

### (Water-Based Solvent)

A water-soluble solvent is used as the solvent, and a relatively hydrophobic solvent having a log Kow of 0 or more is favorable. Examples of this type of solvent include 1,2-pentanediol (log Kow: 0.01), butyl triglycol (same, 0.02), 3-methyl-1,5-pentanediol (same, 0.03), 2-propanol (same, 0.05), dimethyl ether (same, 0.1), 1-propanol (same, 0.25), diethylene glycol diethyl ether (same, 0.39), and triethylene glycol monobutyl ether (same, 0.44).

As water constituting the water-based solvent, for example, ion exchanged water, purified water, distilled water, or the like can be used.

Note that the log Kow is a water/octanol coefficient. The above numerical value of log Kow is a numerical value calculated using Hansen Solubility Parameter in Practice (HSPiP) software.

### (Alkaline Agent)

The alkaline agent constituting the pigment dispersion liquid in this embodiment is used to solubilize the dispersion resin formed of the above block polymer in the water-soluble solvent. The alkaline agent to be used is not particularly limited, but a compound selected from the group consisting of alkali metal hydroxides such as NaOH and KOH can be suitably used.

### (Other Components)

Components other than the above, e.g., a surfactant, or a moisturizing agent, may be blended in the ink according to this embodiment.

The surfactant has the effect of enhancing the wettability of the ink on a recording medium and the effect of enhancing the compatibility and dispersion stability of each component included in the ink. As the surfactant, a nonionic surfactant is favorable. Further, the surfactant imparts appropriate dynamic surface tension to the ink.

### [Preparation of Ink]

The method of preparing the ink according to this embodiment includes, for example, a dispersion step of dispersing a dispersion resin and a pigment in water to prepare a pigment particle dispersion liquid and an addition step of adding an aqueous medium to the pigment particle dispersion liquid to prepare an ink.

### (Dispersion Step)

In this step, a pigment and a dispersion resin are dispersed in water to prepare a pigment dispersion liquid. The content ratio of the pigment to the dispersion resin (mass ratio of the pigment/dispersion resin) is favorably, for example, 60/40 to 90/10.

A pigment dispersion liquid was prepared such that the composition shows in Table 1 was achieved. In this case, the polymer dispersant (dispersion resin) solution was 5.5 mass %, the pigment was 15 mass %, OLFINE (registered trademark) E1010 was 0.5 mass %, and water was the remaining amount.

TABLE 1

| | Mass % |
|---|---|
| Water | 79 |
| Polymer dispersant | 5.5 |
| (dispersion resin) solution | |
| Pigment (e.g., PR-112) | 15 |
| OLFINE E1010 | 0.5 |
| | 100 |

The polymer dispersant (dispersion resin) solution was obtained by adding an aqueous sodium hydroxide solution (alkaline agent) in an amount for neutralizing the carboxyl groups of the block polymer or random polymer used as the dispersion resin (corresponding to the neutralization rate of 40 to 60%) and adding pure water to adjust the solid content to 30%. C.I. Pigment Red (e.g., PR-112) was used as the pigment. OLFINE (registered trademark) E1010 (ethylene oxide adduct of acetylenediol) is a dispersant or a surfactant for enhancing the dispersibility of a pigment.

Examples of the dispersing apparatus to be used for dispersion treatment include a wet dispersing apparatus such as a media disperser such as Nano Grain Mill manufactured by ASADA IRON WORKS. CO., LTD., MSC mill manufactured by NIPPON COKE & ENGINEERING. CO., LTD., and “DYNO (registered trademark)-MILL” manufactured by Shinmaru Enterprises Corporation. As the dispersion conditions, small-diameter beads (0.5 mm q zirconia beads) were set in a vessel, the ejection rate was controlled at 200 to 600 g/min, and a pigment dispersion liquid was prepared such that the average particle diameter was 90 to 110 nm as the dispersion particle size of the pigment dispersion.

Note that the degree of dispersion and the amount of free resin were varied by changing the type of beads. It goes without saying that using a smaller bead diameter makes it easier to achieve micronization, and enhances the coating strength of the resin on the pigment. For measurement of the particle size distribution, a solution diluted 300 times with ion exchanged water was measured using Zetasizer Nano manufactured by Sysmex Corporation.

### (Addition Step)

In this step, a water-based solvent is added to the pigment dispersion liquid prepared as described above. As a result, an ink is obtained. The content of the water-based solvent is favorably 20 to 35 mass %. Note that in this step, another component (more specifically, at least one of a surfactant, a dissolution stabilizer, an anti-drying agent, an antioxidant, a pH adjuster, a moisturizing agent, a penetrating agent, an antifungal agent, or a viscosity adjustor) may be further added as necessary. In this step, it is favorable to stir, after adding the aqueous medium, the obtained mixed solution using a stirrer. The obtained ink may be filtered using a filter (e.g., a filter having a pore size of 5 μm or less) to remove foreign substances and coarse particles.

An ink was prepared by adding each solvent to a pigment dispersion liquid in order while stirring them using a stirrer such that the composition shown in Table 2 was achieved. In this case, the pigment dispersion liquid was 40.0 mass %, the surfactant (“SURFYNOL (registered trademark) 420” manufactured by Nissin Chemical Co., Ltd.) was 0.3 mass %, the water-based solvent was 24 mass % (4.0 mass % of triethylene glycol monobutyl ether and 20.0 mass % of 3-methyl-1,5-pentanediol), glycerin as a moisturizing agent was 5 mass %, and water was the remaining amount.

TABLE 2

| | Mass % |
|---|---|
| Pigment dispersion liquid | 40 |
| SURFYNOL 420 | 0.3 |
| Triethylene glycol monobutyl ether | 4 |
| 3-methyl-1,5-pentanediol | 20 |
| Glycerin | 5 |
| Water | Remainder |
| | 100 |

### EXAMPLE

Examples of the present disclosure will be described.

### Example 1

A pigment dispersion liquid including, as a dispersion resin, a benzylmethacrylate/methacrylic acid block polymer having an acid value of 186 mg KOH/g and a neutralization rate of 58% was prepared such that the composition shown in Table 1 was achieved, and the pigment dispersion liquid was used to prepare an ink having the composition shown in Table 2. For the prepared ink, rubfastness and print density were evaluated.

Note that as the benzylmethacrylate/methacrylic acid block polymer, one having a number average molecular weight (Mn) of 10000 or more and 11000 or less and molecular weight distribution (PDI) of 1.20 or more and 1.23 or less was used (the same applies below).

### (Evaluation of Rubfastness)

In the evaluation of rubfastness, using a tester, the amount of ink to be ejected from one recording head was set to 11.5 pL and a 5 cm×4 cm solid image was printed on copy paper (“CC90” manufactured by Mondi plc). The recording paper on which the solid image was printed was fixed with the printed portion facing up, and unprinted recording paper was stacked thereon. Further, a weight of 1 kg having a base area of 5 cm×4 cm was placed thereon, and the unprinted recording paper and the weight were caused to move horizontally back and forth together under this load. A portion of the unprinted recording paper after the five back and forth rubs, which had been in contact with the printed portion, was measured using a reflection densitometer (FD-9, manufactured by Konica Minolta, Inc.). The measurement conditions were an observation light source D50, an illumination condition M2, a field of view 2°, and a density status I. As the evaluation criteria for rubfastness, the reference density of the recording paper before the rubs was measured, and inks with the value (FD) of less than 0.02 were evaluated to “Pass”, the value (FD) being obtained by subtracting the reference density from the density of the portion that was stacked on the print surface and rubbed.

### (Evaluation of Print Density)

In the evaluation of print density, adjustment was performed with a drive voltage such that 1 dot corresponded to 12 pl, and a 10×10 cm solid image was created on A4-size copy paper (“CC90” manufactured by Mondi plc). Further, 12 hours after, the image density (ID) of the solid image was measured using a reflection densitometer (FD-9, manufactured by Konica Minolta, Inc.). Inks with the ID of 1.3 or more were evaluated to “Pass”.

### Example 2

A pigment dispersion liquid including, as a dispersion resin, a benzylmethacrylate/methacrylic acid block polymer having an acid value of 235 mg KOH/g and a neutralization rate of 51% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Example 3

A pigment dispersion liquid including, as a dispersion resin, a benzylmethacrylate/methacrylic acid block polymer having an acid value of 274 mg KOH/g and a neutralization rate of 43% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Comparative Example 1

A pigment dispersion liquid including, as a dispersion resin, a benzylmethacrylate/methacrylic acid block polymer having an acid value of 138 mg KOH/g and a neutralization rate of 55% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Comparative Example 2

A pigment dispersion liquid including, as a dispersion resin, a benzylmethacrylate/methacrylic acid block polymer having an acid value of 287 mg KOH/g and a neutralization rate of 48% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Comparative Example 3

A pigment dispersion liquid including, as a dispersion resin, a benzylmethacrylate/methacrylic acid block polymer having an acid value of 220 mg KOH/g and a neutralization rate of 32% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Comparative Example 4

A pigment dispersion liquid including, as a dispersion resin, a benzylmethacrylate/methacrylic acid block polymer having an acid value of 251 mg KOH/g and a neutralization rate of 83% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Conclusion

The evaluation results of rubfastness and print density in Examples 1 to 3 and Comparative Examples 1 to 4 are collectively shown in Table 3.

TABLE 3

| | | | | Comparative | Comparative | Comparative | Comparative |
|---|---|---|---|---|---|---|---|
| No | Example 1 | Example 2 | Example 3 | Example 1 | Example 2 | Example 3 | Example 4 |
| Acid value(mgKOH/g) | 186 | 235 | 274 | 138 | 287 | 220 | 251 |
| Neutralization rate(%) | 58 | 51 | 43 | 55 | 48 | 32 | 83 |
| Polymer | Block | Block | Block | Block | Block | Block | Block |
| | polymer | polymer | polymer | polymer | polymer | polymer | polymer |
| Rubfastness | 0.014 | 0.011 | 0.012 | 0.023 | 0.015 | 0.025 | 0.008 |
| Print density | 1.33 | 1.31 | 1.32 | 1.36 | 1.25 | 1.34 | 1.22 |

In Examples 1 to 3, both the rubfastness and the print density were evaluated to be good. That is, the inks according to Examples 1 to 3 in which the dispersion resin (polymer) has an acid value of 180 mg KOH/g or more and 280 mg KOH/g or less and a neutralization rate of 40% or more and 60% or less are capable of achieving both rubfastness and print density because the rubfastness is less than 0.02 and the print density is 1.3 or more.

On the other hand, in Comparative Example 1, since the acid value is low, i.e., 138 mg KOH/g (less than 180 mg KOH/g), the rubfastness was lower than those in Examples 1 to 3. Further, in Comparative Example 2, since the acid value is high, i.e., 287 mg KOH/g (exceeding 280 mg KOH/g), the print density was lower than those in Examples 1 to 3. Further, in Comparative Example 3, since the neutralization rate is low, i.e., 32% (less than 40%), the rubfastness was lower than those in Examples 1 to 3. In Comparative Example 4, since the neutralization rate is high, i.e., 83% (exceeding 60%), the print density was lower than those in Examples 1 to 3.

### Example 4

A pigment dispersion liquid including, as a dispersion resin, a benzylmethacrylate/methacrylic acid block polymer having an acid value of 192 mg KOH/g and a neutralization rate of 49% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Example 5

A pigment dispersion liquid including, as a dispersion resin, a benzylmethacrylate/methacrylic acid block polymer having an acid value of 248 mg KOH/g and a neutralization rate of 55% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Comparative Example 5

A pigment dispersion liquid including, as a dispersion resin, a benzylmethacrylate/methacrylic acid random polymer having an acid value of 224 mg KOH/g and a neutralization rate of 47% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

Note that as the benzylmethacrylate/methacrylic acid random polymer, one having a number average molecular weight (Mn) of 10000 or more and 11000 or less and molecular weight distribution (PDI) of 2.00 or more and 2.20 or less was used (the same applies below).

### Comparative Example 6

A pigment dispersion liquid including, as a dispersion resin, a benzylmethacrylate/methacrylic acid random polymer having an acid value of 253 mg KOH/g and a neutralization rate of 57% was prepared such that the composition shown in Table 1 was achieved, and the pigment dispersion liquid was used to prepare an ink having the composition shown in Table 2. For the prepared ink, rubfastness and print density were evaluated under the same conditions as those in Example 1.

### Conclusion

The evaluation results of rubfastness and print density in Examples 4 and 5 and Comparative Examples 5 and 6 are collectively shown in Table 4.

TABLE 4

| | | | Comparative | Comparative |
|---|---|---|---|---|
| No | Example 4 | Example 5 | Example 5 | Example 6 |
| Acid | 192 | 248 | 224 | 253 |
| value(mgKOH/g) | | | | |
| Neutralization | 49 | 55 | 47 | 57 |
| rate(%) | | | | |
| Polymer | Block | Block | Random | Random |
| | polymer | polymer | polymer | polymer |
| Rubfastness | 0.013 | 0.015 | 0.01 | 0.011 |
| Print density | 1.32 | 1.33 | 1.25 | 1.28 |

In Examples 4 and 5, both the rubfastness and the print density were evaluated to be good, similarly to Examples 1 to 3. That is, the inks according to Examples 4 and 5 in which the dispersion resin (polymer) has an acid value of 180 mg KOH/g or more and 280 mg KOH/g or less and a neutralization rate of 40% or more and 60% or less are capable of achieving both rubfastness and print density because the rubfastness is less than 0.02 and the print density was 1.3 or more.

On the other hand, in Comparative Examples 5 and 6, since the dispersion resin (polymer) has an acid value of 180 mg KOH/g or more and 280 mg KOH/g or less and a neutralization rate of 40% or more and 60% or less but is a random polymer, the print density was lower than those in Examples 4 and 5. This confirmed that in order to achieve both rubfastness and print density, the dispersion resin is favorably a block polymer.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a water-based solvent;
an alkaline agent; and
a dispersion resin,
the dispersion resin being a block polymer that includes a hydrophobic polymer block including benzylmethacrylate and a hydrophilic polymer block including methacrylic acid,
the block polymer having an acid value of 180 mg KOH/g or more and 280 mg KOH/g or less, and
the block polymer having a neutralization rate of 40% or more and 60% or less.

2. The inkjet ink according to claim 1, wherein
the water-based solvent has a log Kow of 0 or more.
